(19) United States
(12) Patent Application Publication
(10) Pub. No.: US 2008/0008544 A1
(43) Pub. Date: Jan. 10, 2008

(54) Blower for inflatable structure

(76) Inventors: Jeffry Lance VanElverginghe, Beaverton, OR (US); Craig B. Adams, Portland, OR (US); Tseng Hsiang Lin, Kuala Lumpur (MY)

Correspondence Address: IPSOLON LLP, 111 SW COLUMBIA, SUITE 710, PORTLAND, OR, 97201, US

(21) Appl. No.: 11/207,990

(22) Filed: Aug. 19, 2005

Related U.S. Application Data
(60) Provisional application No. 60/603,116, filed on Aug. 19, 2004.

(51) Int. Cl. B65G 53/66; E04H 15/20

(52) U.S. Cl. 406/28; 406/99; 52/2.17

(57) ABSTRACT

A stable blower for use primarily with an inflatable structure is disclosed. In one embodiment, the drive axle for the blower's impeller is aligned substantially vertically thereby making it more stable. The inlet and outlet to the blower can be substantially similarly so as to allow the blower to assist with deflation of the inflatable structure by reversing the connection of the blower to the inflatable structure. In another disclosed embodiment, the outlet is aligned substantially vertically so as to allow the blower to be positioned at the base of a leg of a freestanding inflatable structure. The blower's frame can have a domed or a substantially planar top. A two-part impeller with a related conus assembly is also disclosed.

### CROSS-REFERENCE TO RELATED APPLICATION

This application claims priority to U.S. Provisional patent application Ser. No. 60/603,116 filed on Aug. 19, 2004.

### FIELD OF THE INVENTION

The present invention relates to a compact, economical, and stable blower for use primarily with an inflatable structure such as a children's bounce house and the like.

### BACKGROUND OF THE INVENTION

Inflatable structures and blowers for inflating them are known. Examples of these structures can be found in U.S. Pat. No. 4,021,972 to Choate et al., U.S. Pat. No. 4,103,369 to Riordan, U.S. Pat. No. 5,603,185 to Murphy, and U.S. Pat. No. 6,266,927 to Leslie, the disclosures of which are hereby incorporated by reference.

Despite the benefits of the known blowers used to inflate inflatable structures, they have several drawbacks. For example, they tend to be knocked over easily during use, and they are not aesthetically pleasing. Similarly, most inflatable structures do not deflate particularly quickly when not in use.

### SUMMARY OF THE INVENTION

Accordingly, despite the benefits of the known inflatable structures and their related blowers, there remains a need for a cost-effective, aesthetically pleasing blower that is stable during use. In addition to other benefits that will become apparent in the following disclosure, the present invention fulfills these needs.

In one disclosed embodiment the drive axle for the impeller is aligned substantially vertically with the impeller aligned substantially horizontally substantially adjacent to the bottom of the blower so as to lower the center of gravity of the blower thereby making it more stable. The inlet and outlet to the blower are substantially similarly so as to allow the blower to assist with deflation of the inflatable structure simply by reversing the connection of the blower to the inflatable structure.

In another disclosed embodiment, the outlet is aligned substantially vertically so as to allow the blower to be positioned at the base of a leg of a freestanding inflatable structure thereby making the blower integral with the inflatable structure.

### BRIEF DESCRIPTION OF THE DRAWINGS

FIG. 1 is an isometric view of a blower in accordance with an embodiment of the present invention showing a possible connection to an inflatable structure so as IS to allow the blower to inflate the inflatable structure.

FIG. 2 is an isometric view of the blower of FIG. 1 showing a possible connection to the inflatable structure so as to allow the blower to assist with deflating the inflatable structure.

FIG. 3 is a side view of the blower of FIG. 1 taken along line 3-3 of FIG. 1.

FIG. 4 is a tope view of the blower of FIG. 1 taken along line 4-4 of FIG. 3.

FIG. 5 is an alternative preferred blower in accordance with an embodiment of the present invention showing a possible upwardly extending outlet supporting a possible freestanding inflatable structure.

FIG. 6A is a side view of the blower of FIG. 5 taken along line 6A-6A of FIG. 5.

FIG. 6B is a side view of the blower of FIG. 5 taken along line 6B-6B of FIG. 5.

FIG. 7A is an isometric view of a conus in accordance with a preferred impeller structure for use in the blower of the present invention.

FIG. 7B is an isometric view of an upper portion of the impeller structure for use in the blower of the present invention.

FIG. 7C is an isometric view of the lower portion of the impeller structure for use in the blower of the present invention.

FIG. 7D is an isometric view of a fully assembled impeller structure showing possible orientation with respect to each other of the conus of FIG. 7A, the upper portion of FIG. 7B, and the lower portion of FIG. 7C.

### DETAILED DESCRIPTION OF A PREFERRED EMBODIMENT

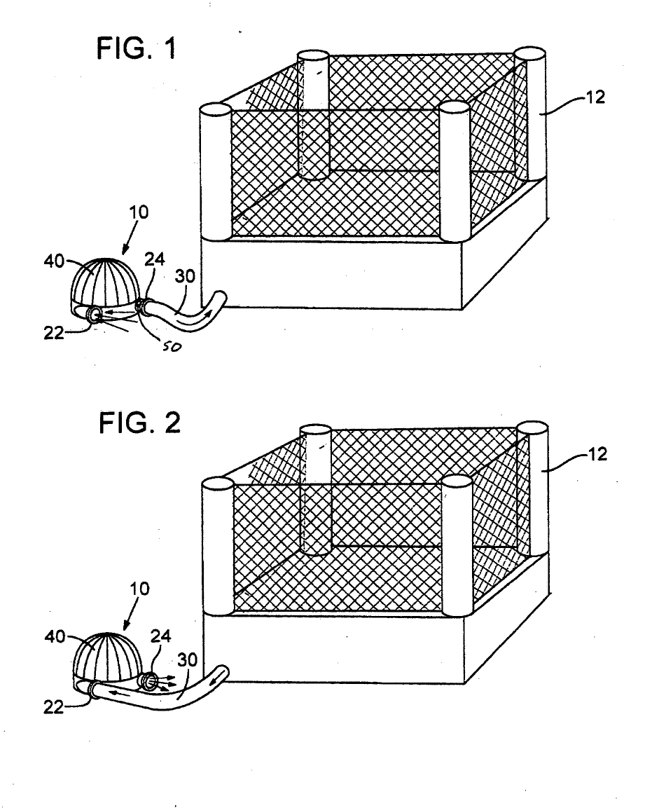

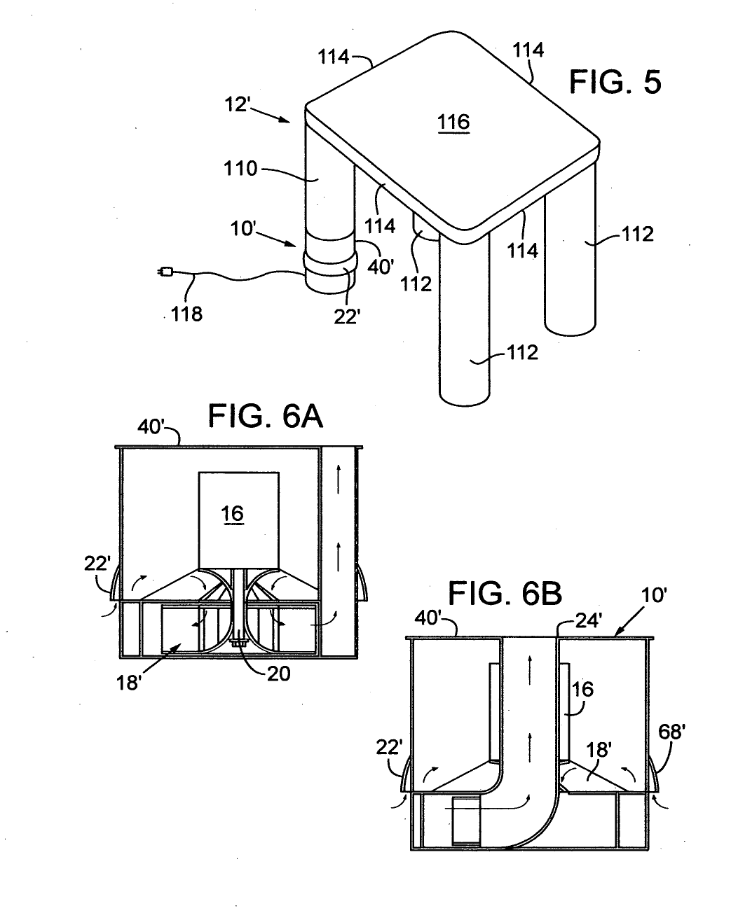

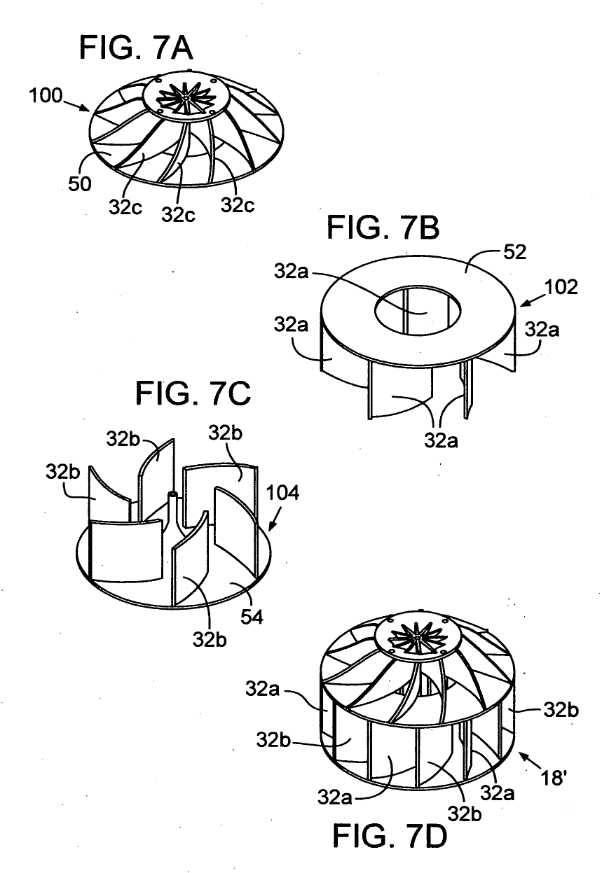

A blower 10 for inflating an inflatable structure 12 is disclosed in FIGS. 1-4. An alternative preferred blower 10′ for inflating an alternative preferred inflatable structure 12′ is disclosed in FIGS. 5-6B, and a preferred impeller structure 18′ for the blower 10, 10′ is disclosed in FIGS. 7A-7D.

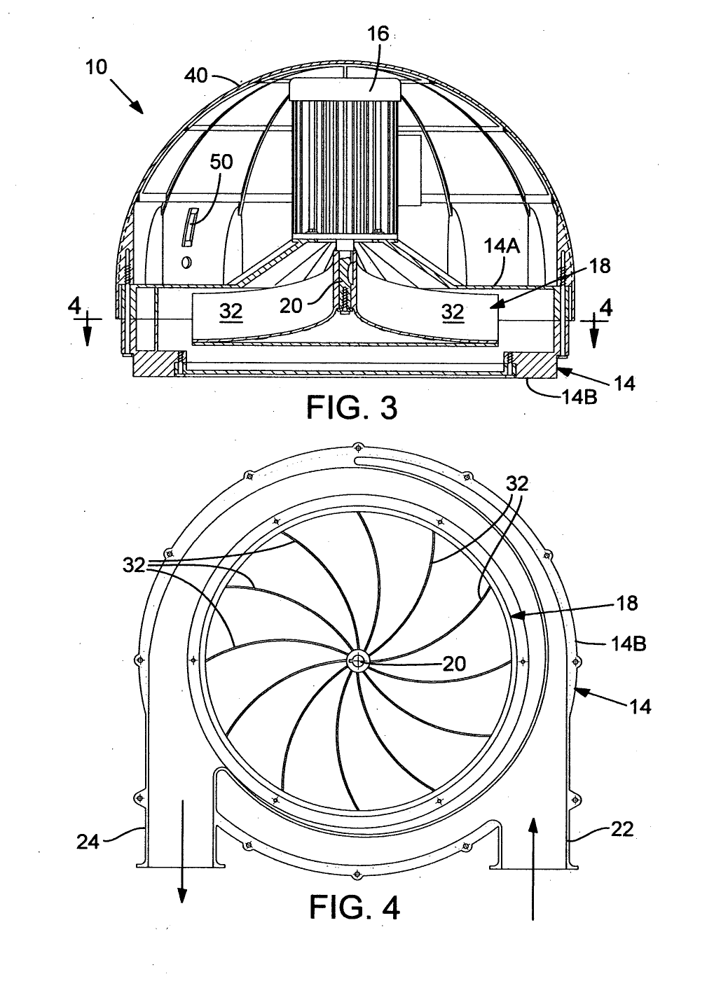

Referring to FIGS. 3 & 4, the blower 10 includes a frame 14 for attaching a motor 16 thereto. The motor 16 drives an impeller 18 with a drive axle 20 such that air enters the frame through an inlet 22 and is driven by the impeller 18 to an outlet 24.

Referring to FIGS. 1 & 2, the inlet 22 and outlet 24 are preferably like sized. More preferably, the inlet 22 and outlet 24 are cylindrical and have the same cross-sectional circumference to thereby allow an air supply tube 30 leading to the inflatable structure 12 to be detachably secured to either the inlet 22 or outlet 24 of the blower 10

Preferably, the motor 16 is electrical and positioned above the impeller 18 with the drive axle 20 aligned substantially vertically as best shown in FIG. 1. More preferably, the impeller 18 is circular with a plurality of spaced-apart curvilinear blades 32 extending therearound as best shown in FIG. 4. By positioning the drive axle 20 substantially vertically and positioning the impeller 18 below the motor 16, the center of gravity of the blower 10 is lowered thereby improving the stability of the blower 10.

Preferably, a hemispherical or dome-shaped cover 40 extends over the motor 16 and impeller 18 as best shown in FIG. 1. The shape of the cover 40 allows it to resemble a ball or the like, thereby rendering it more aestecially pleasing, particularly for use with a children's inflatable bounce house or the like. Moreover, the outer surface 42 of the cover 40 can include surface ornamentation to further improve the aesthetic qualities of the blower 10.

Referring to FIG. 1, the blower 10 can be configured to inflate the inflatable structure 12 by attaching the air supply tube 30 for the inflatable structure 12 to the outlet 24 of the blower 10 and operating the motor 16 of the blower 10. Ambient air is drawn through the inlet 22 of the blower 10, though the blower 10 and air supply tube 30, and into the inflatable structure 12.

Referring to FIG. 2, the blower 10 can also be configured to assist with deflation of the inflatable structure 12 by removing the air supply tube 30 from the outlet 24 and attaching it to the inlet 22 of the blower 10, and then operating the motor 16. Air from the inflatable structure 12 is drawn through the air supply tube 30 into the inlet 22 of the blower 10, through the blower 10, and then released through the outlet 24 of the blower 10.

Preferably, in order to prevent the air supply tube 30 from inadvertently collapsing during deflation of the inflatable structure 12, the air supply tube 30 is either formed of a suitably rigid material, or a support (not shown) or the like is operably secured to the air supply tube 30 during deflation. More preferably, vents 50 are provided in the cover 40 to prevent damaging the motor 16 and other blower components should the primary inlet 22 become blocked during use.

Preferably, the outlet contains a pressure-relief valve 50 (FIG. 1). The valve is preferably positioned within the domed cover and is selected to open when a predetermined pressure is reached thereby preventing the inflatable structure from becoming over filled. If desired, the pressure-relief valve 50 may be manually adjusted, thereby allowing the blower 10 to be used with a wide variety of inflatable structures even if they have different pressurization requirements.

Referring to FIGS. 5-6B, an alternative preferred blower 10′ and inflatable structure 12′ are disclosed. The alternative preferred blower 10′ is substantially similar to the blower 10 of the first preferred embedment. Accordingly, in order to reduce repetition, like elements between these two blower embodiments have been like numbered.

Referring to FIGS. 6A & 6B, the cover 40′ of this blower 10′ is substantially cylindrically shaped and has a substantially flat top surface. The inlet 22′ and outlet 24′ are not shaped substantially similarly. Rather, the inlet 22′ is an opening formed in a circumferential protruding ring around the cover 40′. The outlet 24′ is ducted upward from the impeller 18′ to project air from the blower substantially upward from the top surface of the blower as best shown in FIGS. 6A & 6B. Accordingly, air through the blower 10′ first enters through the inlet 24′, then travels through the conus 100 (FIG. 7A) positioned between the motor 16 and impeller 18′. The air then passed through the rotating impeller 18′, through the exit ducting of the outlet 24′ to thereby be propelled substantially vertically up from the top of the blower.

Referring to FIG. 5, the blower 10′ of this embodiment is particularly well suited for use integral with a free-standing inflatable structure. For example, inflatable structure is a free standing frame having four legs (110, 112) in pneumatic communication with each other via cross supports 114. A canopy 116 extends over the frame thereby forming a shelter. One leg (here leg 110) of the frame includes the blower 10′ positioned below it. Accordingly, by operating the blower, air is transferred to leg and thereby to the remaining portions of the inflatable structure.

Referring to FIGS. 7A-7D, a preferred impeller structure 18′ is disclosed. A conus 100 includes a plurality of substantially triangular-shaped, curved, conus vanes 32c mounted to a conus disk 50 and space apart from each other as best shown in FIG. 7A. Preferably, the components of the conus 100, such as the conus disk 50 and conus vanes 32c, are integrally molded together to form a monolithic structure.

The impeller is preferably formed of an upper portion 102 and a lower portion 104 joined together as best shown in FIG. 7D. The upper portion includes a plurality of spaced-apart and curved upper vanes 32a that are operably secured to an upper disk 52 as best shown in FIG. 7B. The lower portion includes a plurality of spaced-apart and curved lower vanes 32b that are operably secured to a lower disk 54 as best shown in FIG. 7B.

Preferably, the components of the upper portion 102, such as the upper disk 52 and upper vanes 32a are integrally molded together to form a monolithic structure, and the components of the lower portion 104, such as the lower disk 54 and lower vanes 32b, are integrally molded together to form a separate monolithic structure.

Referring to FIG. 7D, the impeller structure 18′ is formed by joining the conus 100, upper portion 102 and lower portion 104 together on the drive axle 20. Preferably, the upper vanes 32a and lower vanes 32b are positioned so as to alternate as shown.

An electrical power chord 118 is preferably operably secured to the motor and extends from the frame as shown in FIG. 5.

In view of the wide variety of embodiments to which the principles of the invention can be applied, it should be apparent that the detailed embodiments are illustrative only and should not be taken as limiting the scope of the invention. Rather, the claimed invention includes all such modifications as may come within the scope of the claims and equivalents thereto.

We claim:

1. A blower for use with an inflatable structure, said blower having:
a frame;
a motor having a drive shaft, said motor operably secured within said frame;
said drive shave mounted substantially vertically within said frame; and,
an impeller operably secured within said frame.

2. The blower of claim. 1, wherein said frame has a substantially planar bottom, and said impeller is aligned substantially near said substantially planar bottom.

3. The blower of claim 1, wherein said frame has an inlet and an outlet, and said inlet is shaped substantially similar to said outlet so as to allow said inflatable structure to connect to either said inlet or said outlet.

4. The blower of claim 1, wherein said frame has an inlet and an outlet, and said outlet extends to a top surface of said frame.

5. The blower of claim 4, wherein said outlet is directed so as to allow air to be expelled substantially vertically from said frame.

6. The blower of claim 4, wherein the inflatable structure has a plurality of legs in pneumatic communication with each other, and said blower is operably positioned directly below and in pneumatic communication one leg of said plurality of legs such that operating the blower inflates the inflatable structure.

7. The blower of claim 1, further including a pressure-relief valve operably secured to said frame and in pneumatic communication with said outlet so as to direct air through said valve when a predetermined are pressure is achieved in said outlet.

8. The blower of claim 7, further including a manual adjustment structure for selecting said predetermined pressure.

9. The blower of claim 1, wherein said frame has a domed top.

10. The blower of claim 1, wherein said frame has a substantially planar top.

11. The blower of claim 1, wherein said impeller is formed to an upper impeller portion joined to a lower impeller portion,
said upper impeller portion having an upper disk and a plurality of upper vanes operably secured to said upper disk; and,
said lower impeller portion having a lower disk and a plurality of lower vanes operably secured to said lower disk.

12. The blower of claim 11, further including a conus operably secured to said impeller.

13. The blower of claim 11, wherein said upper impeller portion is a monolithic structure.

14. The blower of claim 11, wherein said lower impeller portion is a monolithic structure.

15. An inflatable structure having:
a inflatable frame;
a blower in pneumatic communication with said inflatable frame, said blower having:
a substantially rigid frame;
a motor having a drive shaft, said motor operably secured within said substantially rigid frame;
said drive shave mounted substantially vertically within said substantially rigid frame; and,
an impeller operably secured within said frame.

16. The inflatable structure of claim 15, wherein said substantially rigid frame has a substantially planar bottom, and said impeller is aligned substantially near said substantially planar bottom.

17. The inflatable structure of claim 15, wherein said substantially rigid frame has an inlet and an outlet, and said inlet is shaped substantially similar to said outlet so as to allow said inflatable frame to connect to either said inlet or said outlet.

18. The inflatable structure of claim 15, wherein said frame has an inlet and an outlet, and said outlet extends to a top surface of said frame.

19. The inflatable structure of claim 18, wherein said outlet is directed so as to allow air to be expelled substantially vertically from said frame.

20. The inflatable structure of claim 15, further including a pressure-relief valve in pneumatic communication with said inflatable frame so as to direct air through said valve when a predetermined are pressure is achieved in said inflatable frame.
